(19) United States
(12) Patent Application Publication
(10) Pub. No.: US 2014/0338780 A1
(43) Pub. Date: Nov. 20, 2014

(54) COMPRESSED-AIR BRAKE LINE

(71) Applicants: Michael Beyer, Raesfeld (DE); Klaus Gahlmann, Marl (DE); Michael Boeer, Olfen (DE); Karl Kuhmann, Duelmen (DE)

(72) Inventors: Michael Beyer, Raesfeld (DE); Klaus Gahlmann, Marl (DE); Michael Boeer, Olfen (DE); Karl Kuhmann, Duelmen (DE)

(73) Assignee: Evonik Industries AG, Essen (DE)

(21) Appl. No.: 14/276,158

(22) Filed: May 13, 2014

(30) Foreign Application Priority Data
May 16, 2013 (DE) 102013209126.5

(51) Int. Cl. F16L 9/133; B60T 17/04

(52) U.S. Cl. CPC F16L 9/133; B60T 17/04
USPC 138/141; 138/140; 138/177

(57) ABSTRACT

A compressed-air brake line which comprises: I) an external layer made of a moulding composition which comprises at least 50% by weight of PA11 and/or PA12, and II) an internal layer made of a moulding composition which comprises at least 50% by weight of polyamide whose monomer units comprise on average at least 8 C atoms is provided. Layer II) does not contain PA11 and/or PA12. The compressed-air brake line has high bursting strength even at elevated temperature, good low-temperature impact resistance, good ageing resistance, and can be produced at low cost.

### CROSS REFERENCE TO RELATED APPLICATIONS

This application claims priority to German Application No. 102013209126.5. filed May 16, 2013, the disclosure of which is incorporated herein by reference in its entirety.

### BACKGROUND OF THE INVENTION

The invention relates to a pipe which is intended for a compressed-air brake line and which has an external layer made of PA11 or PA12, an internal layer made of a zinc-chloride-resistant polyamide, and optionally an innermost layer made of another zinc-chloride-resistant polyamide.

Compressed-air brake systems are frequently used in heavy-duty vehicles, for example in tractor units and the like. In systems of this type the brake system is activated via compressed air which is passed through a pipe.

Compressed-air brake lines are frequently manufactured from single-layer PA11 or PA12 pipes since these polyamides have very good resistance to environmental effects; multilayer solutions are also available. By means of textile reinforcement it is moreover possible to achieve high bursting pressure with good flexibility. In sectors where mechanical and chemical requirements are not stringent, systems based on polyurethane are mainly used. Particular mention may be made here of the market for semi-trailers and the replacement-part market. These systems are less expensive than systems based on PA11 or on PA12, but they exhibit significant disadvantages in terms of mechanical strength and of chemicals resistance.

Compressed-air brake lines are sometimes placed within the engine compartment, where they are exposed to the heat dissipated from the engine. For this reason, recent years have seen increasing requirements for higher heat resistance, and also for a higher bursting pressure at high temperatures, in order to resist short periods of peak temperatures better than PA11 or PA12 monopipes, or in order to achieve a general improvement in the level of bursting pressure at higher temperatures. Another requirement increasingly encountered is a significant increase in long-term heat resistance or ageing resistance. These requirements have become still more significant since the introduction of the Euro 6 standard and the higher combustion temperature associated therewith.

U.S. Pat. No. 6,670,004 describes a compressed-air brake line composed of a pipe with the layer sequence PA11 or PA12/adhesion promoter/impact-modified PA6 or PA66; this is also optionally followed by a further adhesion-promoter layer, and also a concluding layer made of PA11 or PA12. As an alternative to this, the pipe of U.S. Pat. No. 6,670,004 can have the layer sequence PA612/impact-modified PA6 or PA66/PA612. US 2009/0065085 A1 discloses a pipe with corresponding layer structure but where the PA6 or PA66 of the internal layer comprises no impact modifier. In pipes of this type, the end of the PA6 layer or PA66 layer has no protection at the connection points, and therefore the lack of resistance of these systems to zinc chloride must be considered critical. Furthermore, because of inadequate adhesion between the PA11 layers or PA12 layers and the PA6 layer or PA66 layer it is essential that an adhesion-promoter layer is present, and this makes the structure of the pipe more complicated. In addition to this, PA6 and PA66 absorb large quantities of water at equilibrium.

The object of the present invention consists in avoiding the abovementioned disadvantages and in particular providing a pipe which meets the requirements placed upon a compressed-air brake line with respect to resistance to chemicals, engine oils, zinc chloride and road-salt materials, and which has high bursting strength even at elevated temperature, good low-temperature impact resistance, and good ageing resistance.

### SUMMARY OF THE INVENTION

This object and others have been achieved according to the present invention, the first embodiment of which includes a compressed-air brake line, comprising:

I) an external layer having a moulding composition which comprises at least 50% by weight of PA11 and/or PA12, and

II) an internal layer having a moulding composition which comprises at least 50% by weight of a polyamide whose monomer units comprise on average at least 8 C atoms, with the proviso that PA11 and PA12 are not included.

In another embodiment of the present invention the compressed-air brake line further comprises III) an innermost layer having a moulding composition which comprises at least 50% by weight of polyamide whose monomer units comprise on average at least 8 C atoms.

In various aspects of these embodiments any of the layers I, II and III may comprise a copper-containing stabilizer.

The forgoing description is intended to provide a general introduction and summary of the present invention and is not intended to be limiting in its disclosure unless otherwise explicitly stated. The presently preferred embodiments, together with further advantages, will be best understood by reference to the following detailed description.

### DETAILED DESCRIPTION OF THE PREFERRED EMBODIMENTS

As used herein, the words “a” and “an” and the like carry the meaning of “one or more.” Where a numerical limit or range is stated, the endpoints are included. Also, all values and subranges within a numerical limit or range are specifically included as if explicitly written out. The phrases “selected from the group consisting of,” “chosen from,” and the like include mixtures of the specified materials. Terms such as “contain(s)” and the like are open terms meaning ‘including at least’ unless otherwise specifically noted.

In the first embodiment, the present invention provides a compressed-air brake line which comprises the following layers:

I. an external layer made of a moulding composition which comprises at least 50% by weight, at least 55% by weight or at least 60% by weight, of PA11 and/or PA 12,

II. an internal layer made of a moulding composition which comprises at least 50% by weight, at least 55% by weight or at least 60% by weight, of polyamide whose monomer units comprise on average at least 8, at least 9 or at least 10 C atoms, with the exception of PA11 and PA12, and also

III. optionally an innermost layer made of a moulding composition which comprises at least 50% by weight, at least 55% by weight, or at least 60% by weight, of polyamide whose monomer units comprise on average at least 8, at least 9 or at least 10 C atoms.

In one preferred embodiment, these layers follow one another directly with no intervening adhesion-promoter layer present.

The external layer containing PA11 and/or PA12 according to the invention provides very good zinc-chloride resistance of the compressed-air brake line when comparison is made with a line composed entirely of a moulding composition according to layer II. The lower the average of the number of C atoms per monomer unit, the poorer the zinc-chloride resistance. A monopipe made of a PA612 moulding composition would not be in accord with the invention because PA612 has lower zinc-chloride resistance than PA11 or PA12.

The external diameter of the pipe may usually be in the range from 6 to 20 mm and preferably in the range from 7 to 16 mm, while the wall thickness may be from 1.0 to 2.0 mm. The thickness of the layer II may be from 25 to 90%, preferably from 30 to 80% and particularly preferably from 35 to 70%, of the wall thickness, while the thickness of any adhesion-promoter layers that may be present is respectively from 0.02 to 0.2 mm, preferably from 0.04 to 0.16 mm and particularly preferably from 0.06 to 0.14 mm. Any adhesion-promoter layers that may be present are preferably thinner than the respectively adjacent external layer and, respectively, innermost layer.

The polyamide of the layer II may be produced from a combination of diamine and dicarboxylic acid, from an ω-aminocarboxylic acid or from the corresponding lactam. The ω-aminocarboxylic acid or the lactam according to the invention comprises at least 8, at least 9 or at least 10 C atoms. In the case of mixtures of lactams, it is the arithmetic average that is considered according to the invention. In the case of a combination of diamine and dicarboxylic acid, the arithmetic average of the C atoms in diamine and dicarboxylic acid must be at least 8, at least 9 or at least 10. Examples of suitable polyamides are: PA610 (which can be produced from hexamethylenediamine [6 C atoms] and sebacic acid [10 C atoms], the average of the C atoms in the monomer units here therefore being 8), PA88 (which can be produced from octamethylenediamine and 1,8-octanedioic acid), PA8 (which can be produced from caprylolactam), PA612, PA810, PA108, PA9, PA613, PA614, PA812, PA128, PA1010, PA10, PA814, PA148, PA1012, PA1014 and PA1212. The production of the polyamides is conventionally known. It may also be possible, of course, to use copolyamides based on these materials, and it may also be optionally possible to make concomitant use of monomers such as caprolactam, with the proviso that the average of the number of the C atoms complies with the abovementioned condition. In one preferred embodiment, the polyamide of the layer II may be produced from a combination of diamine and dicarboxylic acid.

The polyamide may also be a polyetheresteramide or a polyetheramide. Polyetheramides are described in DE-A 30 06 961. They comprise a polyetherdiamine as comonomer. Suitable polyetherdiamines are obtainable via conversion of the corresponding polyetherdiols through reductive amination or coupling to acrylonitrile with subsequent hydrogenation (e.g. EP-A-0 434 244; EP-A-0 296 852). They generally have a number-average molecular weight of from 230 to 4000; the proportion of these in the polyetheramide is preferably from 5 to 50% by weight.

Polyetherdiamines based on propylene glycol are commercially available as ELASTAMIN® grades from Huntsman. In principle, polyetherdiamines based on 1,4-butanediol or 1,3-butanediol may also have good suitability, as also do mixed-structure polyetherdiamines, for example with random or blockwise distribution of the units derived from the diols. The hard block of the polyetheresteramide or polyetheramide is formed from a low-molecular-weight polyamide as defined above for the layer II.

In one preferred embodiment, the crystallite melting point Tₘ of the polyamide of the layer II, measured by DSC in accordance with ISO 11357 during the second heating procedure, is at least 182° C., particularly at least 188° C., in particular at least 195° C. and very particularly at least 200° C.

The moulding composition of the layer II may also comprise PA11 or PA12 in addition to the polyamide defined above—polyetheresteramides and polyetheramides also being included. In this case the material comprises from 0.01 to 50% by weight, preferably from 0.1 to 45% by weight and particularly preferably from 1 to 40% by weight, of a polyamide selected from PA11, PA12, a polyetheresteramide based on PA11 or PA12, a polyetheramide based on PA11 or PA12, and also mixtures thereof.

In a first embodiment, the layer III, like the layer I, is composed of a moulding composition based on PA11 and/or PA12. In a second embodiment layer III, like layer II, is composed of a moulding composition based on polyamide whose monomer units comprise on average at least 8, at least 9 or at least 10 C atoms, with the exception of PA11 and PA12. In a third embodiment, the layer III is composed of a moulding composition based on a mixture of polyamide whose monomer units comprise on average at least 8, at least 9 or at least 10 C atoms, and also PA11 and/or PA12.

The moulding compositions of the individual layers generally have good compatibility with one another, and no adhesion-promoter layers are therefore necessary. The compatibility may be additionally improved if at least one of the layers comprises a polyolefinic compound which has acid groups or anhydride groups, by way of example one of the impact modifiers mentioned below. It may thus be possible to reduce the number of the layers, and this makes the production process less complicated.

If the moulding compositions of the individual layers are not sufficiently compatible with one another, secure bonding of the layers may be achieved with the aid of an adhesion-promoter layer located therebetween. A suitable adhesion promoter may be a moulding composition based on a polyamide which has sufficient compatibility with the materials of the two adjacent layers, or based on a mixture of the polyamides present in the adjacent layers. The adhesion-promoting effect may be increased if the adhesion promoter additionally comprises an impact modifier which, as is usual for polyamide moulding compositions, bears anhydride groups, for example a maleic-anhydride-functionalized ethylene-propylene rubber or an ethylene-acrylate-maleic anhydride terpolymer. Other suitable adhesion promoters are maleic-anhydride- or acrylic-acid-functionalized polyolefins which are available commercially with the trademark ADMER® or BYNEL®.

The moulding compositions of the individual layers may generally comprise, in addition to polyamide, other components, e.g. impact modifiers, other thermoplastics, plasticizers, and also other conventional additional substances needed in order to establish particular properties. Examples of these are pigments and fillers such as carbon black, titanium dioxide, zinc sulphide, silicates or carbonates, processing aids such as waxes, zinc stearate or calcium stearate, flame retardants, glass fibres, antioxidants, UV stabilizers, and also additions which provide antielectrostatic properties or electrical conductivity to the product, examples being carbon fibres, graphite fibrils, stainless-steel fibres and conductive carbon black.

Suitable impact modifiers are those conventionally used for polyamide moulding compositions, examples including maleic-anhydride-functionalized ethylene-propylene rubber, maleic-anhydride-functionalized styrene-ethylene/butene block copolymers, acrylate rubber and the like.

Examples of conventional compounds suitable as plasticizers are esters of p-hydroxybenzoic acid having from 2 to 20 C atoms in the alcohol component and amides of arylsulphonic acids having from 2 to 12 C atoms in the amine component, preferably amides of benzenesulphonic acid.

Plasticizers used include inter alia ethyl p-hydroxybenzoate, octyl p-hydroxybenzoate, isohexadecyl p-hydroxybenzoate, N-n-octyltoluenesulphonamide, N-n-butylbenzenesulphonamide (BBSA) or N-2-ethylhexylbenzenesulphonamide. It is also possible moreover to use a phosphorus-containing flame retardant as plasticizer, an example being a phosphate or phosphonate, e.g. diphenyl cresyl phosphate.

Examples of other thermoplastics which may be present in the moulding compositions of the individual layers are polyolefins, preferably functionalized with maleic anhydride or the like; or a polyamide that does not accord with the claims, for example PA6 or PA66.

In one preferred embodiment, a copper-containing stabilizer may be present in the moulding composition of the external layer I.

In another preferred embodiment, a copper-containing stabilizer is present not only in the moulding composition of the external layer I but also in the moulding composition of the internal layer II, particular preference of this embodiment being given to the absence of any layer III.

In another preferred embodiment, a copper-containing stabilizer is present not only in the moulding composition of the external layer I but also in the moulding composition of the innermost layer III.

In another embodiment, a copper-containing stabilizer may be present not only in the moulding composition of the external layer I and in the moulding composition of the internal layer II, but also in the moulding composition of the innermost layer III.

Examples of suitable copper compounds include copper salts such as copper chloride, copper bromide, copper iodide, copper acetate, copper stearate and copper acetylacetonate.

These compounds may advantageously be combined with an alkali metal halide or alkaline earth metal halide, and particularly suitable compounds according to the invention include sodium bromide, potassium bromide, sodium iodide and potassium iodide. It may be advantageous to use, as copper-containing stabilizer, a mixture of CuI and KI, where the CuI/KI ratio is typically in the range from 1:5 to 1:15.

The use of copper-containing stabilizers of this type in polyamide moulding compositions is conventionally known and corresponding stabilizer systems are available commercially.

The amount used of the copper-containing stabilizer is preferably such that the copper content, calculated as Cu, of the stabilized polyamide moulding composition is in the range from 0.001% by weight to 0.05% by weight and particularly in the range from 0.002% by weight to 0.03% by weight. A higher copper content may provide only an insignificant improvement of stabilization, but sometimes may have a noticeable adverse effect due to the intrinsic colour of the copper. On the other hand, if copper content is below 0.001% by weight the stabilizing effect is inadequate.

According to the invention, the copper-containing stabilizer may be used together with an organic stabilizer. Corresponding mixed stabilizer systems are available commercially.

The copper-containing stabilizer achieves long-term stabilization with respect to loss of mechanical properties at high long-term service temperatures, and also efficient stabilization with respect to polymer degradation during processing.

The compressed-air brake line of the invention may have the layer configurations shown in the table. For the sake of simplicity, the table shows only the polyamides on which the moulding compositions are based, and also the copper-containing stabilizer present.

In the event of higher requirements placed on bursting strength, the pipe may additionally comprise textile reinforcement corresponding to conventional practice. The textile reinforcement may be present either within a layer or between two layers. The application of the textile layer to the external layer of the pipe with subsequent rubber coating may be the technically simplest manufacturing solution. Rubber used according to the invention may either be a vulcanizable rubber or a thermoplastic elastomer, e.g. Santopren. The coating with rubber may also take place without application of any textile layer.

The pipe of the invention may be used as compressed-air brake line, for example in lorries, in semi-trailers, in lorry trailers or in other trailers. The operating pressure at which the lines are generally operated are up to 12.5 bar in lorries and 8.5 bar in semi-trailers and trailers.

TABLE 1
Examples of layer configurations

| | | Adhesion-promoter | | | |
|---|---|---|---|---|---|
| | External layer I | layer | Internal layer II | Adhesion-promoter layer | Innermost layer III |
| 1 | PA 12 | — | PA612 | — | — |
| 2 | PA12, Cu-stabilized | — | PA612 | — | — |
| 3 | PA12, Cu-stabilized | — | PA612, Cu-stabilized | — | — |
| 4 | PA12, Cu-stabilized | — | PA612 | — | PA12, Cu-stabilized |
| 5 | PA12, Cu-stabilized | — | PA612, Cu-stabilized | — | PA12, Cu-stabilized |
| 6 | PA11, Cu-stabilized | — | PA612 | — | — |
| 7 | PA11, Cu-stabilized | — | PA612, Cu-stabilized | — | — |
| 8 | PA11, Cu-stabilized | — | PA612 | — | PA11, Cu-stabilized |
| 9 | PA11, Cu-stabilized | MA-modified PP or | PA612, Cu-stabilized | MA-modified PP or | PA11, Cu-stabilized |
| | | PA11/PA612 blend, | | PA11/PA612 blend, Cu- | |
| | | Cu-stabilized | | stabilized | |
| 10 | PA12, Cu-stabilized | PA12/PA610 blend, | PA610, Cu-stabilized | | |
| | | Cu-stabilized | | | |
| 11 | PA12, Cu-stabilized | PA612 | PA610, Cu-stabilized | — | PA612, Cu-stabilized |
| 12 | PA12, Cu-stabilized | — | PA1010, Cu-stabilized | — | — |
| 13 | PA12, Cu-stabilized | — | PA1010, Cu-stabilized | — | PA12, Cu-stabilized |
| 14 | PA12, Cu-stabilized | — | PA1012, Cu-stabilized | — | PA12, Cu-stabilized |
| 15 | PA12, Cu-stabilized | — | PA1212, Cu-stabilized | — | PA12, Cu-stabilized |
| 16 | PA12, Cu-stabilized | — | PA1012/PA1212 blend, | — | PA12, Cu-stabilized |
| | | | Cu-stabilized | | |
| 17 | PA12, Cu-stabilized | — | PA1010/PA12 70:30 | — | PA12, Cu-stabilized |
| | | | blend, Cu-stabilized | | |
| 18 | PA12, Cu-stabilized | — | PA612, Cu-stabilized | — | PA1012, Cu-stabilized |
| 19 | PA12, Cu-stabilized | — | PA613, Cu-stabilized | — | PA12/PA613 40 : 60 |
| | | | | | blend, Cu-stabilized |

The following moulding compositions were used in the examples below:

VESTAMID® LX9013, an impact-modified, plasticized PA12 moulding composition for extrusion

VESTAMID® X7393, an impact-modified, plasticized PA12 moulding composition for extrusion

VESTAMID® DX9303, an impact-modified, plasticized PA612 moulding composition for extrusion

A multilayer pipe system was used to produce three-layer pipes corresponding to Inventive Example 1, and also monopipes corresponding to Comparative Example 1 with external diameter 12 mm and wall thickness 1.5 mm, and a bursting test in accordance with DIN 53758 was then carried out on these. Hoop strength was seen to be considerably better in the three-layer pipe of the invention, in particular at higher temperatures.

Comparative Example 1 used VESTAMID® X7393 because this comprises somewhat less impact modifier and plasticizer than VESTAMID® LX9013, and monopipes were thus obtained with almost the same flexibility as the three-layer pipe of Inventive Example 1. Comparable results were thus ensured. VESTAMID® X7393 is moreover a standard moulding composition for the manufacture of compressed-air brake lines.

TABLE 2
Layer configurations and hoop strength

| | | Inventive Example 1 | Comparative Example 1 | Improvement |
|---|---|---|---|---|
| Layer Configurations | | 0.15 mm VESTAMID ® LX9013 | 1.5 mm VESTAMID ® X7393 | |
| | | 1.2 mm VESTAMID ® DX9303 | | |
| | | 0.15 mm VESTAMID ® LX9013 | | |
| Hoop strength [MPa] | 23° C. | 30.8 | 30.0 | 2.7% |
| | 120° C. | 12.4 | 9.9 | 25% |
| | 150° C. | 7.7 | 5.1 | 51% |

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A compressed-air brake line, comprising:
I. an external layer having a moulding composition which comprises at least 50% by weight of PA11 and/or PA12, and
II. an internal layer having a moulding composition which comprises at least 50% by weight of a polyamide whose monomer units comprise on average at least 8 C atoms, with the proviso that PA11 and PA12 are not included.

2. The compressed-air brake line according to claim 1,
further comprising:
III. an innermost layer having a moulding composition which comprises at least 50% by weight of polyamide whose monomer units comprise on average at least 8 C atoms.

3. The compressed-air brake line according to claim 1,
wherein the external layer I further comprises a copper-containing stabilizer.

4. The compressed-air brake line according to claim 3,
wherein the internal layer II further comprises a copper-containing stabilizer.

5. The compressed-air brake line according to claim 2,
wherein the innermost layer III comprises a copper-containing stabilizer.

6. The compressed-air brake line according to claim 3, wherein
a copper content of the external layer I is from 0.001 to 0.05% by weight.

7. The compressed-air brake line according to claim 4, wherein
a copper content of the internal layer II is from 0.001 to 0.05% by weight.

8. The compressed-air brake line according to claim 5, wherein
a copper content of the innermost layer I is from 0.001 to 0.05% by weight.

9. The compressed-air brake line according to claim 1, further comprising:
an adhesion-promoter layer bonding the layers I and II to one another.

10. The compressed-air brake line according to claim 2, further comprising:
an adhesion-promoter layer bonding the layers II and III to one another.
